(19) United States
(12) Patent Application Publication
(10) Pub. No.: US 2007/0080194 A1
(43) Pub. Date: Apr. 12, 2007

(54) Heat shield with a sandwich construction

(76) Inventors: Uwe Duckek, Langenau (DE); Bruno Goerlich, Weissenhorn (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/545,900

(22) Filed: Oct. 11, 2006

(30) Foreign Application Priority Data
Oct. 11, 2005 (EP) 05022095.3

(51) Int. Cl. A47J 36/02

(52) U.S. Cl. 228/101

(57) ABSTRACT

A heat shield is disclosed having first and a second three-dimensionally deformed metal layers which are connected to one another such that an outer edge section of the first metal layer is flanged on the second metal layer around substantially the entire circumference of the outer edge of the second metal layer. The outer edge section is welded regionally in at least one partial area of the second metal layer. A method for producing the heat shield is also disclosed.

### CROSS-REFERENCE TO RELATED APPLICATIONS

This application claims the benefit of EP 05022095 filed Oct. 11, 2005 which is hereby incorporated by reference in its entirety.

### TECHNICAL FIELD

The present disclosure relates to a heat shield in sandwich construction having first and second three-dimensionally deformed metal layers, which are connected to one another along their outer edges in that an outer edge section of one of the metal layers is flanged back around the outer edge of the other metal layer.

### BACKGROUND

Heat shields are used as noise and/or heat protection for other components. For example, heat shields are used in engine compartments of motor vehicles, particularly in the area of the exhaust system, to protect neighboring temperature-sensitive components and assemblies from impermissible heating. The heat shields are often used simultaneously as a noise protector. To improve the damping properties, an insulating layer is frequently enclosed between the two metal layers. The insulating layer comprises mica, temperature-stable paper, inorganic or organic fiber composite materials, or other suitable insulation materials, for example. The metallic layers typically comprise steel, aluminum-plated steel, or aluminum.

The shapes of the heat shields are typically tailored to the components to be protected and their other surroundings. In the field of internal combustion engines in particular, where one trend is going toward situating the required components to save as much space as possible and closely neighboring one another to shrink the engine compartment, heat shields must often be deformed three-dimensionally very strongly. This three-dimensional deformation is typically performed in heat shields in sandwich construction after the individual, initially planar layers of the heat shield have been connected to one another. During the deformation, the material of the sandwich layers is subjected to strong stress through compressions and stretches. This stress particularly acts on the outer edge area, in which the outer metallic layers are connected to one another. If the metal layers are connected by flanging the other edge section of one metal layer around the outer edge section of the outer metal layer, the danger arises that cracks will result in the area of the flange and the flange will open in strongly curved areas. For very strongly three-dimensionally deformed heat shields, it was therefore typical until now to divide the heat shield into multiple separate areas, produce each of these alone and deform them three-dimensionally, and only subsequently connect them to one another to form the finished heat shield by riveting or welding, for example. However, this method is complex and costly.

Therefore, there is a need for a heat shield in sandwich construction which may be produced in a simple and cost-effective way using a flange as a connection between the outer metal layers, without strong three-dimensional deformation resulting in problems such as opening or cracking in the flange area.

### SUMMARY

A heat shield is disclosed wherein the heat shield includes first and second three-dimensionally deformed metal layers, which are connected to one another in that an outer edge section of the first metal layer is flanged around substantially the entire circumference of an outer edge of the second metal layer. The outer edge section of the first metal layer is welded only regionally to the second metal layer in at least one partial area. A method of making a heat shield is also disclosed.

### BRIEF DESCRIPTION OF THE DRAWINGS

The present invention will be explained further on the basis of figures in the following. Theses figures are used only to describe an especially preferred embodiment of the present invention, without restricting it to the example shown, however. In the figures:

FIG. 1 schematically shows a heat shield in a perspective side view;

FIG. 2 schematically shows a perspective view of the interior of the heat shield from FIG. 1;

FIG. 3 schematically shows a top view of the interior of the heat shield from FIG. 1;

FIG. 4 schematically shows a cross-section along line A-A of FIG. 2; and

FIG. 5 schematically shows a perspective view of the interior of a prior art heat shield.

### DETAILED DESCRIPTION OF THE INVENTION

Illustrative embodiments are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

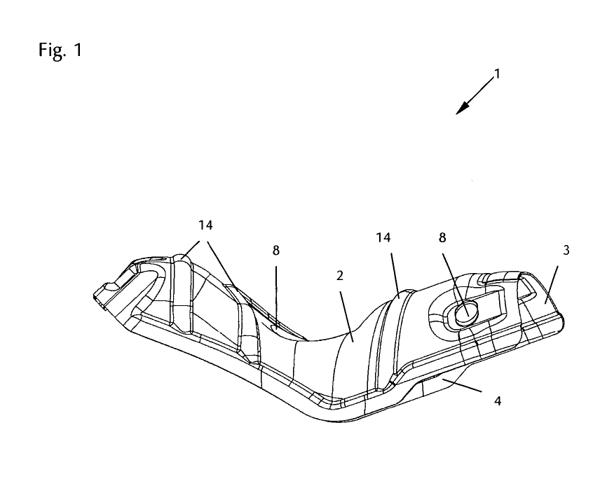

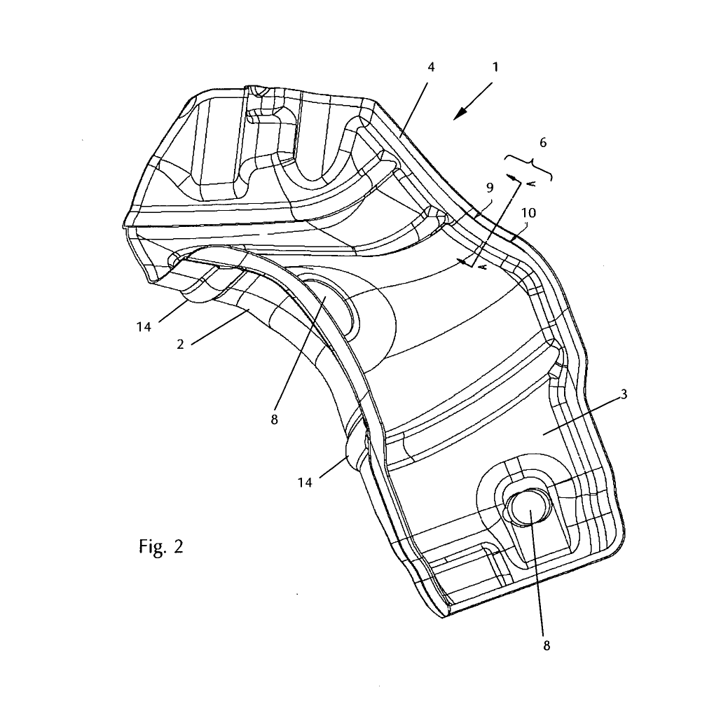

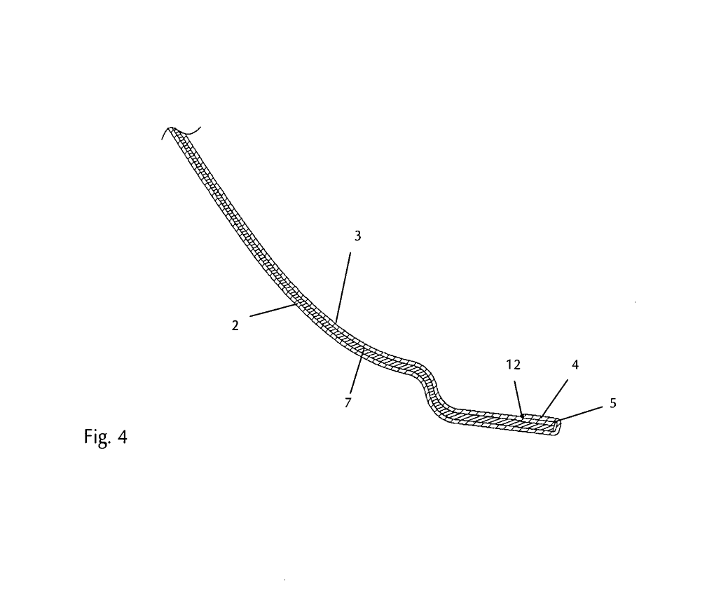

FIGS. 1 through 4 each show a heat shield 1 in sandwich construction. The heat shield 1 comprises an outer metal plate 2 and a second metal plate 3 pointing toward a cavity enclosed by the heat shield 1. The metal plates 2 and 3 may comprise steel, aluminum-plated steel, or aluminum, for example. An insulating layer 7 (best seen in FIG. 4) is situated between the metal plates 2 and 3, which may comprise mica, heat-resistant paper, inorganic or organic fiber composite material, for example. The three layers 2, 3, and 7 are connected to one another in such a manner that an outer edge section 4 of the first metal plate 2 is flanged on the second metal plate 3 back around the outer edge 5 of the second metal plate 3 (see FIG. 4). The flange thus formed runs closed substantially along the entire outer edge of the heat shield 1 (see FIG. 2 in particular). The width of the flanged outer edge section 4 is approximately 3 to 3.5 mm. Multiple beads 14 are provided in the area of the layers 2 and 3, which are primarily used for the purpose of providing material for a reshaping process. In addition, the layers 2, 3, and 7 have through openings 8, which are either used as screw through holes or through which measuring probes or similar devices may be guided, for example.

The outer edge section 4 which is flanged around substantially the entire circumference is to be understood as a flange which was flanged around at least about 80% and particularly at least about 90%, of the longitudinal extension of the outer edge of the second metal plate. The areas not provided with a flange may, for example, be used as ventilation openings or for similar purposes. However, it is preferable if the flange runs completely around the outer edge of the heat shield 1.

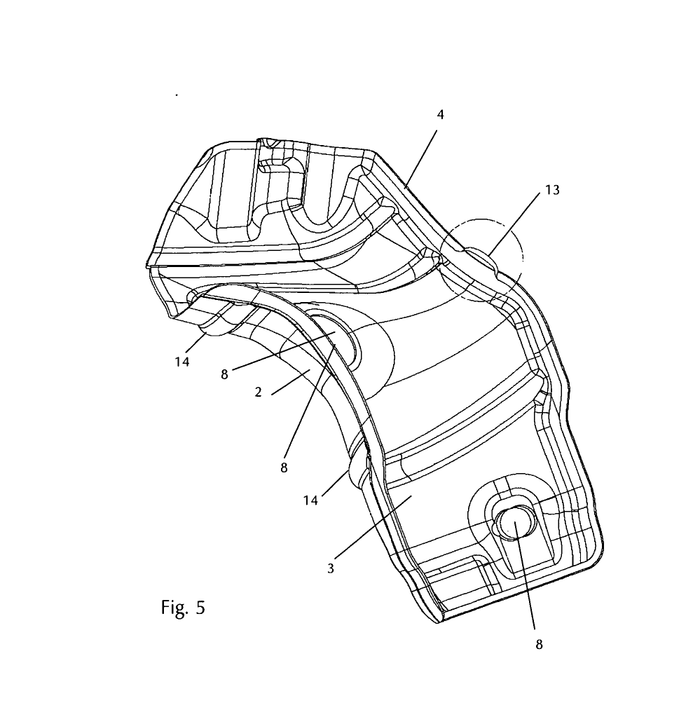

The heat shield 1 is strongly three-dimensionally deformed. It is curved up approximately U-shaped from longitudinal edge to longitudinal edge, while it is buckled approximately V-shaped between the narrow sides. The shaping is performed in that the—except for the flanged outer edge sections 4 and the beads 14—in that the initially planar metal layer 2 and 3 and the insulating layer 7 lying between them are embossed into the three-dimensional shape in a suitable embossing die. During this embossing procedure, strong forces act on the material of the metal layers 2 and 3. In the prior art, the stress and stretches arising in the area of the flanged outer edge section 4 may result in the material in the flanged outer edge section 4 tearing of the flange standing up away from the second metal layer 3. This is shown in FIG. 5. In the right, circled area of the figure, a section of the outer edge section 4 is identified by 13 has lifted off of the second metal layer 3 and now projects outward.

To prevent flaws of the type described above, in the heat shield according to an embodiment of the present invention from FIGS. 1 through 4, the outer edge section 4 is secured in critical partial areas using a weld bond 12. The partial area of the outer edge section 4 secured using a weld bond is identified by 6 in FIG. 2. A weld bond is produced in partial area 6 between the points 9 and 10, in which the outer edge section 4 is welded onto the second metal layer 3. As may be inferred from FIG. 4, the weld seam 12 runts as a substantially linear weld seam along the outer edge of the outer edge section 4. The weld bond 12 is produced before—except for the flange and the beads—the planar metal plates 2 and 3 are three-dimensionally deformed.

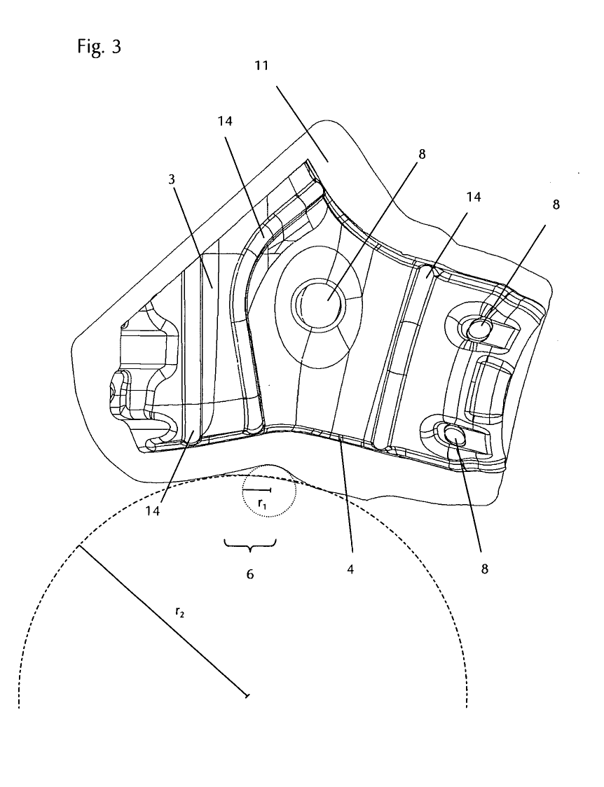

As may be inferred from FIGS. 1 through 3, the partial area 6 in which the weld bond is produced is located in an area of the heat shield in which the contour of the outer edge section 4 arches inward toward the interior of the heat shield. Stress occurs in the material here already during the flanging, since it must be strongly stretched. FIG. 3 illustrates this. The heat shield preform, identified by 11, is illustrated before the three-dimensional deformation on the basis of its outer contour. For comparison, the deformed heat shield is drawn inside the contour. The critical partial area 6 is shown in the lower area of the figure. The preform 11 has an outer contour which is arched strongly inward here, whose radius of curvature is identified by r₁, and is approximately 33 mm. This corresponds to a material stretch of approximately 40% in this flange area.

The outer edge section (flange) 4 may be situated on the inside or on the outside of the heat shield 1. The at least one welded-on partial area 6 is located in those areas of the outer edge section 4 which are more strongly three-dimensionally deformed than the other areas of the outer edge section. The welded-on partial area 6 secures the flanged outer edge section 4 against opening in spite of stronger stress acting thereon and simultaneously prevents cracking in this area. The number and arrangement of the partial areas 6 primarily depends on the shape of the three-dimensional heat shield 1. These welded partial areas 6 are expediently situated on all those points of the outer edge of the heat shield 1 which are subjected to especially strong deformations and stress. The dimensions of the partial areas 6 are also selected in accordance with these criteria. A partial area 6 will normally have a length of up to 50 mm and typically no more than 30 mm. Even if multiple partial areas 6 are used along the outer edge section 4, these are only provided regionally in any case. It is thus not necessary to weld the first and second metal layers 2, 3 to one another along the entire outer edge of the heat shield 1. This significantly reduces time outlay and costs in the production of the heat shield 1. In addition, it is not necessary to divide the heat shield 1 into individual partial segments during the production, which must be produced separately and subsequently connected to one another. This also results in a significant savings in time and costs.

During the three-dimensional deformation of the precursor stage into the final shape, it is curved in a U-shape. The partial area 6 is simultaneously located in the area of the V-shaped buckling of the heat shield 1, which may be seen best in FIG. 1. In order to achieve this shape, the precursor stage must be drawn outward in the partial area 6, which results in the radius of curvature in this area being enlarged. The edge curve of the final shape is shown as a dashed line beside the outer contour curve of the precursor stage 11 for illustration. The radius of curvature r₂ is greatly enlarged in relation to the radius of the curvature r₁, which corresponds to a further material stretch in the partial area 6 of approximately 38%. Because of this, the probability that the flange will open outward away from the second metal layer 3 or even tear during the three-dimensional deformation of the layers 2, 3, and 7 is especially large. In order to prevent this, the outer edge section 4 is secured by the weld bond 12 precisely at this point. The occurrence of flaws in the flange area may thus be securely prevented.

One method of producing the heat shield 1 includes situating the first and second metal layers 2, 3 over one another as substantially planar layers. The first metal layer 2 occupies a larger area than the second metal layer 3, so that the outer edge section 4 of the first metal layer 2 may be flanged around the outer edge of the second metal layer 3 and come to rest on the second metal layer 3. The flanged outer edge section 4 of the first metal layer 2 goes around substantially the entire circumference of the outer edge of the second metal layer 3 and connects the first and second metal layers 2, 3 to one another. Substantially planar layers are to be understood as those metal layers in which a predominant part of their area lies within one plane. These comprise layers in which beads have already been embossed, for example, which provide material for the later three-dimensional deformation, for example. The outer edge sections, which are later bent underneath the second metal layer as the flange, may also already be erected in the essentially planar first metal layer. Such a cup-like intermediate stage of the first metal layer 2 may accommodate the second metal layer 3 and where required additionally an insulating layer 7 situated between the two metal layers 2, 3 especially well. The outer edge sections 4 may expediently be pressed together jointly with the embossing of possibly provided beads. After the flanging, the outer edge section 4 of the first metal layer 2 is welded to the second metal layer 3 regionally within the at least one partial area 6 of the outer edge section 4. Finally, the first and second metal layers 2, 3 three-dimensionally are deformed to result in the heat shield. Welding on the outer edge section 4 in the at least one partial area 6 prevents cracks arising in the area of the flange during the deformation of the metal layers 2, 3 or the flange opening during or after the deformation.

The welding may be performed as spot welding, laser welding, or especially preferably as capacitor-discharge welding. If an insulating layer 7 is situated between the first and second metal layers 2, 3, the insulation layer 7 is sized such that the at least the partial areas 6 to be welded are exposed in the flanged outer edge section 4. In other words, the insulative layer 7 is sized such that sufficient electrical contact is available for the welding. In the case of spot welding or laser welding, it is to be ensured that the flanged outer edge section 4 presses solidly against the second metal layer 3. Thus, there is to be no air gap between the flanged outer edge section 4 of the first metal layer 2 and the second metal layer 3, which may impair the strength of a laser weld bond 12. Such an air gap would also interfere with spot welding, since the copper electrodes typically used are only poorly suitable for pressing the metal layers solidly against one another. In addition, a suitable adjustment of pressure and current strength to one another must be ensured during spot welding. However, if these suggestions are followed, the welding step may be performed in a way known in principle using the tools known from the prior art.

The method step of welding the flanged outer edge section 4 on the second metal layer 3 is incorporated without further measures into the other method steps for producing a heat shield 1. The remaining method steps may be performed in a way known per se using the tools typical until now. Stamping the outer contours of the first and second metal layers 2, 3 free and stamping through openings into these metal layers are thus expediently performed using a typical stamping tool. Stamping the outer contours free and stamping in the through openings may be performed in a single step. However, it is preferable to stamp in the through openings simultaneously in both metal layers only after the flanging and welding of the outer edge section 4 and especially only after the three-dimensional deformation. The stamping steps may also be replaced by laser cutting. Flanging the outer edge section 4 is performed using a typical flanging tool. It is expedient to weld the metal layers 2, 3 to one another while connected to one another by flanging while still inside the flanging tool in the at least one partial area 6 of the flanged outer edge section 4. Only following the welding procedure is the heat shield 1 preform expediently three-dimensionally deformed in a typical embossing die to result in the heat shield 1.

The weld bond 12 in the partial area 6 of the outer edge section 4 may in principle have any arbitrary shape which is capable of ensuring that the first and second metal layers 2, 3 are held together adequately. The weld bond 12 is preferably implemented as a linear or spot seam, which runs along the edge of the outer edge section 4 of the first metal layer 2. As already noted, in one embodiment the partial areas 6 in which the weld bond 12 is produced has a length of up to about 50 mm and particularly up to about 30 mm. The width of the flanged outer edge section 4 is expediently between approximately 1 and 6 mm and particularly between approximately 3 and 4 mm. In the at least one partial area 6 in which a weld bond is provided, the width of the flanged outer edge section 4 may also have its width reduced in relation to the neighboring areas. In this way, the stress acting on the material may be reduced further in this area. However, it is to be ensured that the flange width is not reduced so much that there is no longer an overlap with the second metal layer 3. In addition, the flange is not to be narrowed so much that the electrodes used for producing the weld bond 12 wear out too rapidly.

The points along the outer edge section 4 which expediently form partial areas 6 for situating a weld bond 12 are particularly those in which the material of the outer edge section 4 which forms the flange must stretch at least about 10% and particularly at least about 20% upon three-dimensional deformation of the metal layers in relation to the starting state before the three-dimensional deformation. Material stretches in the longitudinal extension direction of the outer edge section 4 are to be noted in particular. Material stretches this strong typically result in either cracks arising in this area of the flange or the flange drawing away outward from the second metal layer 3.

Those partial areas 6 of the outer edge section 4 which lie in inwardly curved areas of the outer contour of the first metal layer 2 are especially loaded by stress. Especially strong loads of the outer edge section 4 occur here already during the flanging of the outer edge section 4 in the essentially planar first metal layer 2, since the material in this area must be stretched around the arched bending edge during flanging. The strength of the curvature may be established on the basis of the radius of curvature of the outer edge of the flange after folding over. Experience teaches that it is not possible to work with a too small radius; a minimum radius of curvature should exceed about 10 mm, preferably about 12 mm. Critical areas which come into consideration as partial areas 6 in which a weld bond 12 is to be situated are those having a radius of curvature of up to about 40 mm. A radius of curvature of this type typically indicates that the material of this partial area 6 of the outer edge section 4 will experience a stretch in the longitudinal extension direction of the outer edge section 4 of at least about 30% in relation to the non-flanged state. Stretches of about 40% or more are frequently observed. The stretches to be expected may also be used as a criterion for which areas of the outer edge section 4 is advisable to produce weld bonds 12. Finally, this may be clarified through prior experiments, in which it is checked in which areas of the outer edges section 4 cracks occur or the flange opens. Weld bonds 12 according to an embodiment of the present invention are applied here to secure the outer edge section 4 on the second metal layer 3.

The areas described above are particularly threatened by crack formation and opening of the flange, since the flange is already under stress therein before the three-dimensional deformation. The danger of cracking and opening of the flange rises additionally when further stress is built up in these areas during the three-dimensional deformation. This may be the case, for example, if transverse stress occurs in addition to the longitudinal stretching, for example, if a deformation upward or downward in the direction of the flange width also occurs. Additional longitudinal stretches due to reshaping on a larger radius or similar conditions may also result in flaws in this flange area. As a rule of thumb, an (additional) material stretching of a least about 10% and particularly about 20% or more during the reshaping of the preform into the three-dimensional final shape will cause flaws. It is therefore especially desirable to provide weld bonds 12 in these partial areas 6.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1-19. (canceled)

20. A heat shield comprising:
a first three-dimensionally deformed metal layer;
a second three-dimensionally deformed metal layer;
wherein the first and second metal layers are connected to one another such that an outer edge section of the first metal layer is flanged around the second metal layer around substantially the entire circumference of an outer edge of the second metal layer; and
wherein the outer edge section of the first metal layer is welded only regionally to the second metal layer in at least one partial area.

21. The heat shield according to claim 20, wherein the at least one partial area is three-dimensionally deformed more strongly than other areas of the outer edge section.

22. The heat shield according to claim 20, wherein the at least one partial area lies in an inwardly curved area of the outer edge section.

23. The heat shield according to claim 22, wherein the inwardly curved area of the outer edge section is additionally curved upward or downward in a flange width direction.

24. The heat shield according to claim 20, wherein the first and second metal layers were formed by three-dimensionally deforming two substantially planar metal layers that were stacked together and wherein at least one partial area lying in an area of the outer edge section is subject to a material stretch of at least about 10% during the three-dimensional deformation of the metal layers.

25. The heat shield according to claim 20, wherein the outer edge section is subject to a material stretch of at least about 20% during the three-dimensional deformation of the metal layers.

26. The heat shield according to claim 20, wherein the outer edge section has a width of about 1 to 6 mm.

27. The heat shield according to claim 20, wherein the outer edge section has a width of about 3 to 4 mm.

28. The heat shield according to claim 20, wherein the width of the outer edge section is less in the at least one partial area than the width outside the partial area.

29. The heat shield according to claim 20, wherein the at least one partial area has a length of up to about 50 mm.

30. The heat shield according to claim 20, wherein the at least one partial area has a length of up to about 30 mm.

31. The heat shield according to claim 20, wherein the weld bond is implemented as a linear or spot weld seam along the edge of the outer edge section.

32. The heat shield according to claim 20, wherein an insulating layer is positioned between the first and second metal layers.

33. The heat shield according to claim 32, wherein the insulating layer is not provided in the area of the flanged outer edge section.

34. A method for producing a heat shield, comprising:
positioning first and a second substantially planar metal layers in a stacked relationship;
flanging an outer edge section of the first metal layer around an outer edge of the second metal layer and on to the second metal layer to form a flange, wherein the flange extends substantially around the entire outer edge of the second metal layer and connects the first and second metal layers to one another,
regionally welding at least one partial area of the outer edge section to the second metal layer, and subsequently
three-dimensionally deforming the first and second metal layers.

35. The method according to claim 34, wherein the welding step is performed as spot welding.

36. The method according to claim 34, wherein the welding step is performed in a flanging tool.

37. The method according to one of claim 34, wherein the welding step is performed a partial area whose material has experienced a material stretch in the longitudinal extension direction of at least-about 30% during the flanging of the outer edge section.

38. The method according to one of claim 34, wherein the welding step is performed in a partial area that lies in an inwardly curved area of the outer edge section.

39. The method according to claim 38, wherein the inwardly curved area of the outer edge section has a radius of curvature of less than about 40 mm.

40. The method according to one of the claim 34, wherein the welding step is performed in a partial area whose material experiences a material stretch in the longitudinal extension direction of the outer edge section of at least about 10% during the three-dimensional deformation step.

41. The method according to one of claim 34, further comprising the positioning an insulating layer between the first and second metal layers so as to leave the at least one partial area to be welded exposed.
